(19) United States
(12) Patent Application Publication
(10) Pub. No.: US 2026/0341168 A1
(43) Pub. Date: Oct. 29, 2026

(54) CORPUS-BASED GENERATION AND INTERACTIVE PRESENTATION OF LANGUAGE LEARNING RESOURCES

(71) Applicant: Lang.Guru LLC, Oakland, CA (US)

(72) Inventor: Zinaida Pozen, Oakland, CA (US)

(21) Appl. No.: 19/714,245

(22) Filed: Jun. 19, 2026

Related U.S. Application Data
(63) Continuation of application No. 19/661,138, filed on Apr. 28, 2026, now abandoned.
(60) Provisional application No. 63/796,116, filed on Apr. 28, 2025.

(51) Int. Cl. G09B 5/02; G06F 40/205; G06F 40/268; G06F 40/284; G06F 40/30; G06F 40/58

(52) U.S. Cl. CPC G09B 5/02; G06F 40/205; G06F 40/268; G06F 40/284; G06F 40/30; G06F 40/58

(57) ABSTRACT

A computer-implemented method and system for generating language learning resources. The system accesses text data in a target language and processes the text data to generate a plurality of language units representing linguistic elements of the text data. The system computes, based on the text data, scores associated with the language units. The system generates relationship instances representing relationships between select language units of the plurality of language units. The system stores the language units, the scores, and the relationship instances. Responsive to detecting a selection of a user-selectable element in a user interface of a computing device, the system retrieves a subset of the language units based on at least one of the scores or the relationship instances. The system causes display of the subset of the language units in the user interface.

### CLAIM OF PRIORITY

This application is a continuation of U.S. patent application Ser. No. 19/661,138, filed Apr. 28, 2026, which claims the benefit of priority to U.S. Provisional Patent Application Ser. No. 63/796,116, filed Apr. 28, 2025, the contents of which are incorporated herein by reference in their entirety.

### TECHNICAL FIELD

Embodiments of the present disclosure relate generally to the field of education or language learning platforms and, more particularly, but not by way of limitation, to systems and methods for constructing and presenting educational content for interactive language instruction.

### BACKGROUND

Language learning application development involves a variety of approaches to educational resource generation, selection, and presentation. Conventional approaches often rely on manually curated content, fixed lesson sequences, and predetermined rule-based progressions. Producing such content for a given target language typically requires substantial human effort from linguists, translators, and curriculum designers, which limits the number of languages that can be supported and the rate at which content can be updated or expanded.

Conventional approaches also present technical limitations in how learning content is selected and ordered. Rule-based progressions may not reflect the statistical characteristics of actual language usage, and example sentences are often constructed or selected without systematic measures of complexity, frequency, or representativeness within a given language. As a result, learners may encounter examples that do not correspond to common conversational usage, or that introduce grammatical structures in an order that does not align with the structural complexity of the examples themselves.

Further limitations arise in the presentation of relationships among language units. Identifying semantically related words, structurally similar phrases, or representative usage examples for a given word or phrase is computationally demanding, and conventional systems often rely on static lookup tables or predefined associations. Such static structures do not scale across languages and do not readily adapt to new corpora or user-specific learning goals.

Another category of approaches applies large language model (LLM) based generation to produce language instruction content. Such approaches present technical limitations for language instruction applications. Generated content is produced through probabilistic token prediction rather than through systematic analysis of attested usage in a language corpus, and may include linguistic constructions that do not correspond to usage patterns in the target language. Generated content also lacks traceability to source material, which limits the ability to verify accuracy or to surface representative examples associated with a particular linguistic element. Additionally, output quality varies as a function of the quantity of training data available for a given language, with reduced quality for languages represented by smaller training corpora.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an example system for automatically generating language learning resources and using the generated language learning resources in a language learning application, according to some examples.

FIG. 2 is a block diagram illustrating a learning resource generation system, according to some examples.

FIG. 3 is a block diagram illustrating a view of a learning resource generation system, according to some examples.

FIG. 4 is a block diagram illustrating a language learning application, according to some examples.

FIG. 5 is an illustration of an example user interface (UI) displayed in connection with a language learning application, according to some examples, the UI configured to receive user input relating to customization of a language learning experience.

FIG. 6 is an illustration of an example UI displayed in connection with a language learning application, according to some examples, the UI configured to receive user input relating to selection of a unit type.

FIG. 7 is an illustration of an example UI displayed in connection with a language learning application, according to some examples, the UI configured to display language units associated with a selected unit type and example utterances associated with the language units.

FIG. 8 is an illustration of an example UI displayed in connection with a language learning application, according to some examples, the UI configured to display grammatical information associated with a selected language unit.

FIG. 9 is a flowchart illustrating a method for automatically generating language learning resources and using the generated language learning resources in a language learning application, according to some examples.

FIG. 10 is a flowchart illustrating a method for constructing a study set and generating an interactive session based on the study set, according to some examples.

FIG. 11 is a flowchart illustrating a method for navigating language units based on relationship instances, according to some examples.

FIG. 12 is a flowchart illustrating a method for building a word list from one or more seed language units, according to some examples.

FIG. 13 is a block diagram showing a machine-learning program, according to some examples.

FIG. 14 is a block diagram illustrating components of a machine, according to some examples, able to read instructions from a machine-readable medium and perform any one or more of the methodologies discussed herein.

FIG. 15 is a block diagram illustrating an example of a software architecture that may be installed on a machine, according to some examples.

### DETAILED DESCRIPTION

Developing language learning applications presents technical challenges in resource generation, content selection, and adaptive presentation. Conventional language learning solutions guide users through predetermined series of rules and instructions oriented toward memorization, without systematically connecting the instructional content to realistic conversational situations or to domains of interest to a particular user. Users may lack visibility into the basis for the progression through rules, instructions, and examples. Other solutions incorporate game-like elements to increase user engagement but operate on fixed instructional content with predetermined presentation ordering, and may rely on examples that do not reflect authentic usage patterns of a target language.

Additionally, generating language learning resources manually for multiple target languages requires substantial human effort, which limits the scalability of such solutions across languages and domains.

Examples in the disclosure herein refer to a system that automatically generates educational data assets (e.g., language learning instruction materials) from text data in a target language, and enables use of the generated data assets in an interactive language learning application that adapts presented content to a user's preferences and needs. The generated data assets include language units representing linguistic elements of the text data, such as utterances (e.g., sentences), tokens (e.g., word forms), lemmas (e.g., word roots), phrases, and grammatical representations of utterances (e.g., delexicalized parses). Language units may be automatically annotated with morphological information, grammatical features, part-of-speech information, lexical definitions, and translations from the target language to an instruction language. Generated data assets may also include standalone grammatical structures and other language structures derived from the text data.

In some examples, the system generates the educational data assets by processing one or more corpora (e.g., conversational content corpora) using one or more text analysis operations, such as tokenization, lemmatization, part-of-speech tagging, morphological analysis, dependency parsing, and machine translation. The system computes, based on the processed text data, one or more scores associated with the language units, such as usage frequency scores, salience scores, complexity scores, and perplexity scores. The scores may be computed using a set of machine learning models, such as language models trained or estimated on the text data. The computed scores are used to annotate, rank, filter, or otherwise process the language units for downstream use, including identifying progressions of language units ordered by complexity for presentation to users. The system automatically generates relationship instances representing relationships between select language units, including semantic similarity relationships between lemmas or phrases, grammatical structure similarity relationships between utterances, translation relationships between language units in the target language and corresponding language units in an instruction language, and usage example relationships between language units.

In some examples, the relationship instances are generated by computing feature vectors (e.g., embeddings) for language units and determining similarity or relatedness based on the feature vectors. The language units, associated scores, and relationship instances are stored as data assets accessible via an application programming interface (API) for downstream use.

In some examples, the language learning application receives information about a user's preferences, such as target language of interest, instruction language of interest, proficiency level, type of language unit to study, and domain of interest (e.g., law, technology, medicine, literature, travel, everyday conversations). Responsive to detecting selections of user-selectable elements in a user interface, the language learning application retrieves subsets of the generated language units based on the scores or the relationship instances and causes display of the subsets in the user interface. The language learning application enables the user to navigate through language units and associated relationships, for example by selecting a first language unit to cause display of one or more additional language units related to the first language unit based on the relationship instances.

In some examples, the language learning application generates interactive exercises based on selected subsets of language units, such as matching exercises in which user-selectable elements corresponding to language units in the target language are associated with user-selectable elements corresponding to translations of the language units in the instruction language, with accuracy scores computed based on the associations. The language learning application may be deployed as a native mobile application executing on a client device (e.g., a smart phone or tablet) and may support multimodal interactions through text-to-speech (TTS) technology, speech recognition and transcription technology, or a combination thereof. In some examples, the language learning application is implemented as a web application accessible through a browser, with support for offline functionality to enable on-device learning.

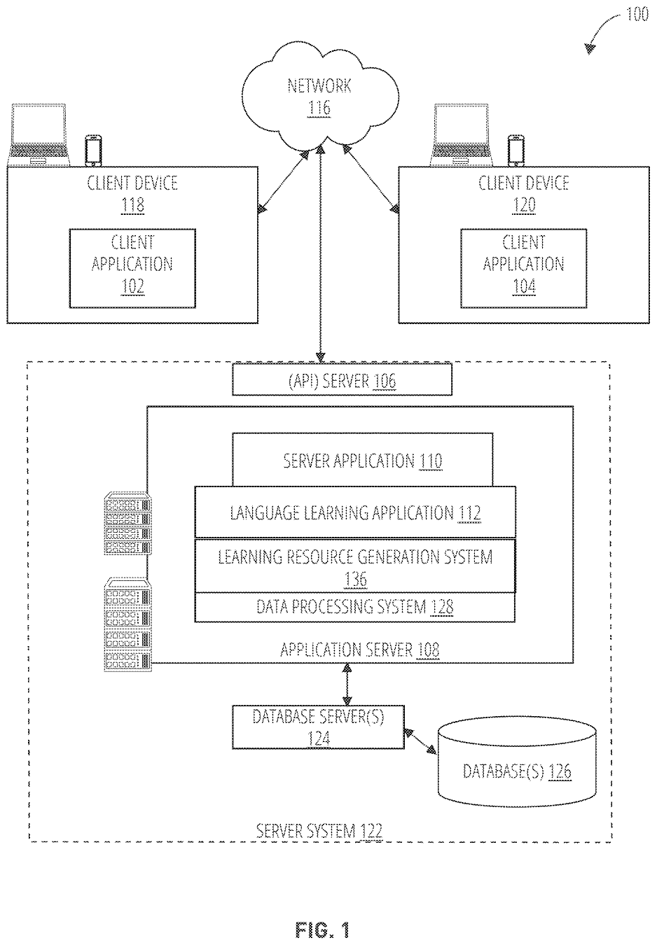

FIG. 1 is a block diagram showing an example system 100 for automatically generating language learning resources and/or using them in a language learning application. The system 100 includes one or more client devices (e.g., client devices 118 and 120) that host one or more applications, including client applications 102 and 104.

Each client application (e.g., 102) is able to communicate and exchange data with another client application (e.g., 104) and with the server application 110 executed at the server system 122 via the network 116. The data exchanged between a client application (e.g., 102 or 104) and the server system 122 includes functions (e.g., commands to invoke functions) as well as payload data. The payload data may include, for example, text data, audio data, video data, or other multimedia data, corresponding to language units, educational data assets, interactive exercises, user preferences, user progress data, user engagement data, or other data associated with language learning operations.

The server system 122 provides server-side functionality via the network 116 to client applications 102 and 104. While certain functions of the system 100 are described herein as being performed by either client application 102 and 104 or by the server system 122, the location of certain functionality either within a client application or the server system is a design choice. For example, certain technology and functionality may be initially deployed within the server system 122 and later migrated to client applications 102 or 104 where there is sufficient processing capacity. In some examples, one or more of client applications 102 and 104 support offline functionality to enable on-device language learning operations independent of the server system 122.

The server system 122 supports various services and operations that are provided to client applications (e.g., 102 and 104). Such operations include transmitting data to, receiving data from, and processing data generated by the client applications. In some examples, this data includes user preference data, user profile data, user progress data, user engagement data, language selection data, and data associated with educational data assets such as language units, language unit scores, and relationship instances. Data exchanges within the system 100 are invoked and controlled through functions available via graphical user interfaces (GUIs) of the client application 102 and 104.

Turning now specifically to the server system 122, an Application Programming Interface (API) server 106 is coupled to, and provides a programmatic interface to, an application server 108. The application server 108 is communicatively coupled to database server(s) 124, which facilitate access to one or more database(s) 126 that store data associated with data generated by client applications 102 and 104 and processed by the application server 108.

The API server 106 receives and transmits data (e.g., commands and payloads) between client devices 118 and 120 and the application server 108. Specifically, the API server 106 provides a set of interfaces (e.g., routines and protocols) that can be called or queried by the client applications 102 and 104 in order to invoke functionality of the application server 108. The API server 106 exposes various functions supported by the application server 108, including account registration, login functionality, retrieval of educational data assets (e.g., language units, language unit scores, and relationship instances), retrieval of examples of language unit usage, retrieval of related language units based on relationship instances, submission of user preferences and user progress data, and submission of user feedback regarding educational data assets.

The application server 108 hosts a number of applications and subsystems, including a server application 110, a language learning application 112, and a data processing system 128.

The server application 110 implements a number of data processing technologies and functions, particularly related to the accessing, creating, updating, and other processing of data (e.g., educational data assets) by client application 102 or 104. Processing of data that involves substantial processor or memory resources may be performed server-side by the server application 110.

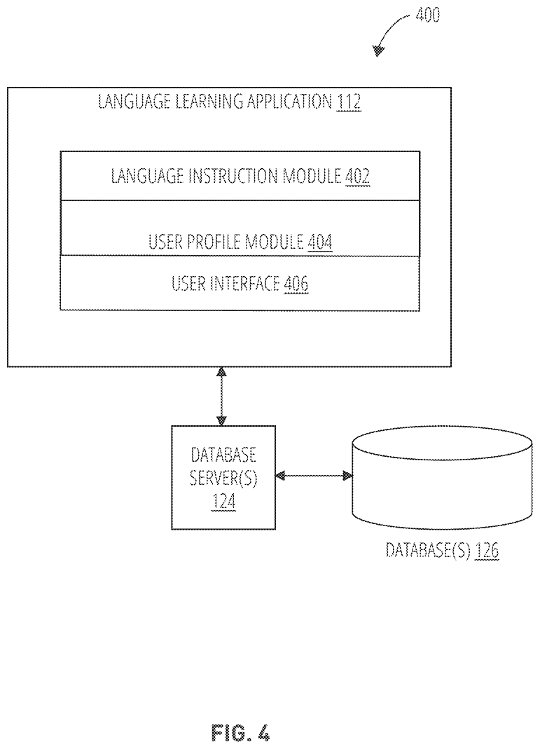

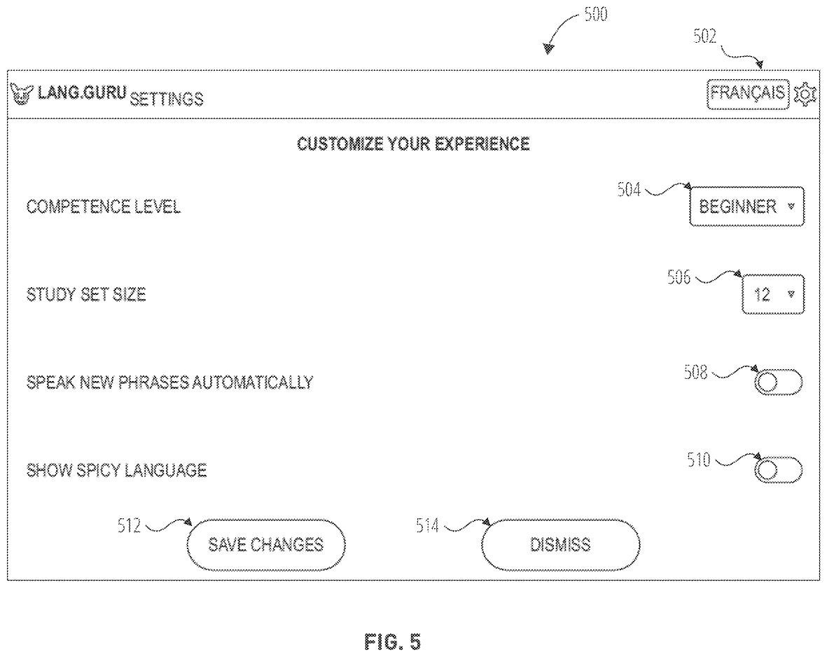

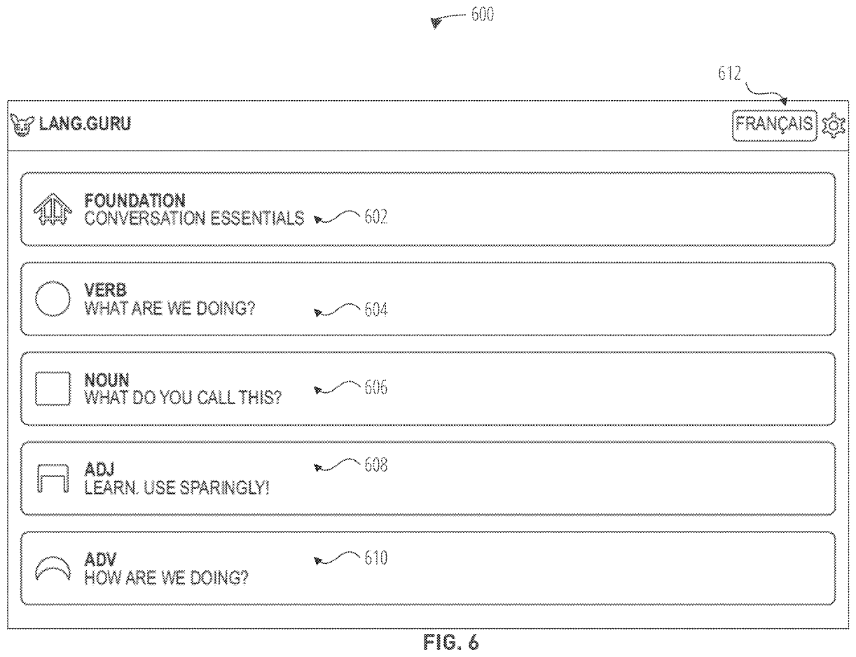

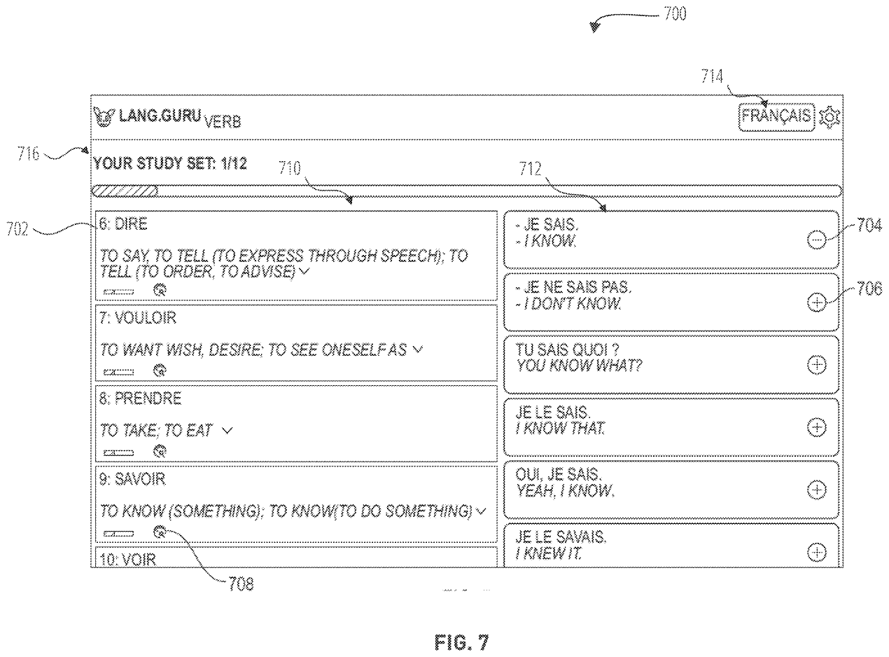

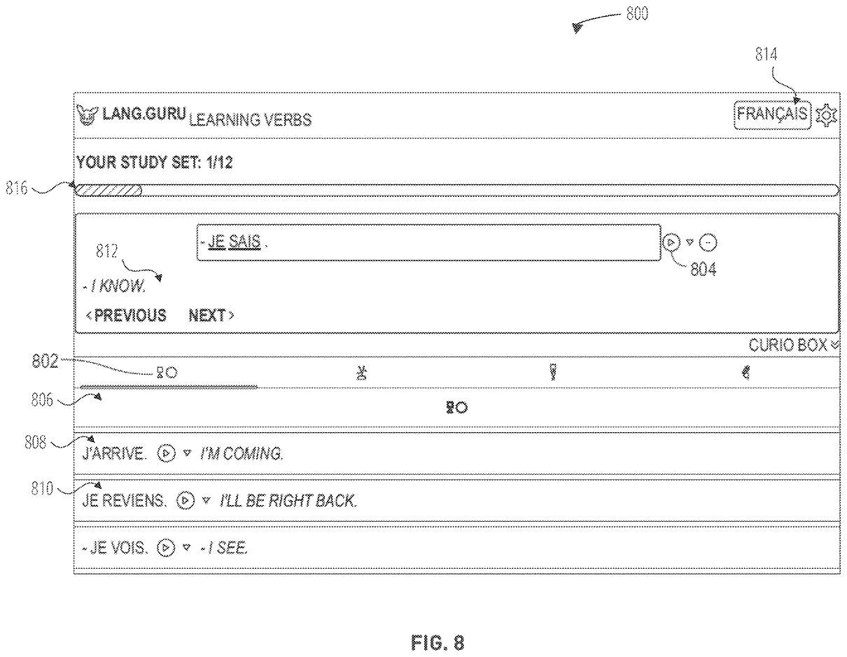

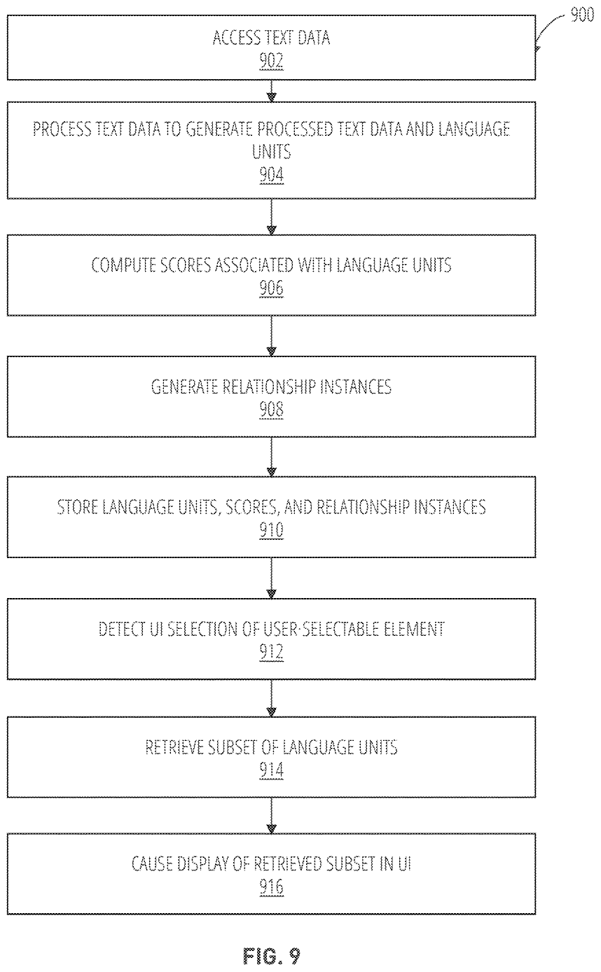

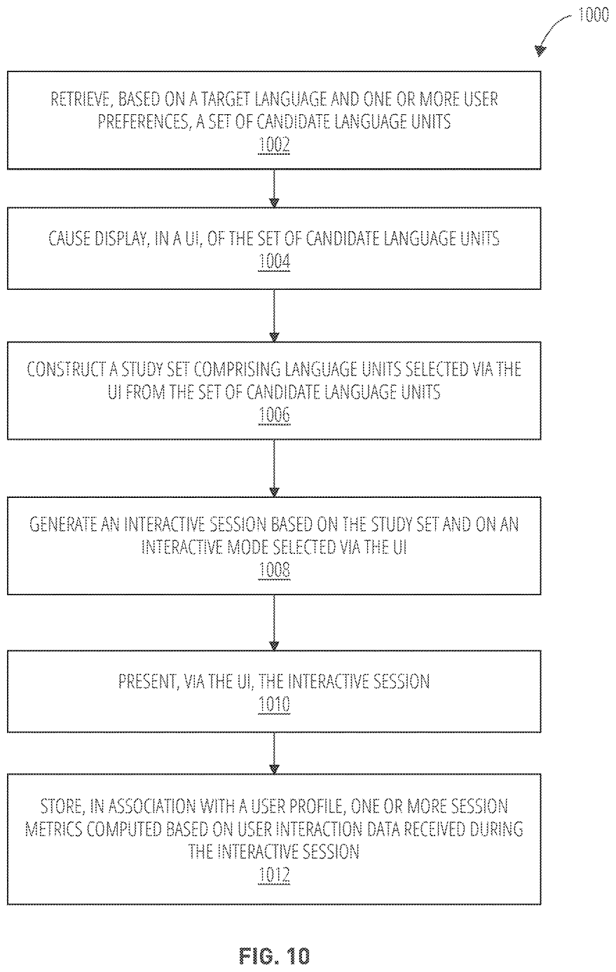

The language learning application 112 implements a number of technologies and functions, particularly related to retrieving, searching, and/or presenting educational data assets to one or more users of a client device 118 or client device 120 (e.g., users learning a target language) via a communication between a client application (e.g., 102 or 104) and the language learning application 112 running on server system 122. The language learning application 112 may also generate interactive exercises based on selected educational data assets, evaluate user responses to the interactive exercises, and track user progress and user engagement data. Further details of the language learning application 112 can be found at least in the detailed descriptions of FIG. 4, FIG. 5, FIG. 6, FIG. 7, FIG. 8, FIG. 8, FIG. 9, FIG. 9, and FIG. 10.

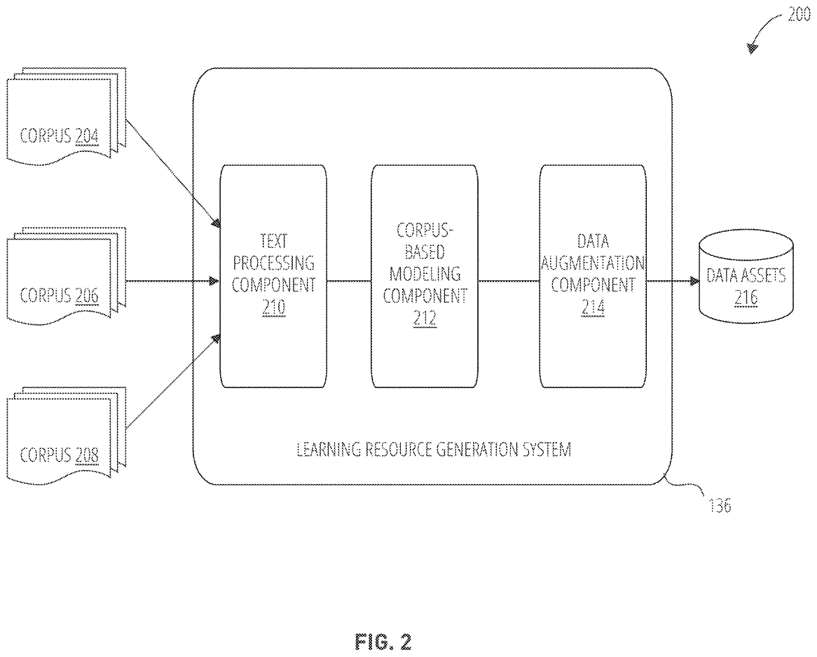

The data processing system 128 implements a number of technologies and functions, particularly related to generating, accessing, updating, and/or aggregating data generated or processed by client applications (such as 102 or 104) and/or by applications and subsystems of server system 122. In some examples, the data processing system 128 includes a learning resource generation system 136 that is described in at least FIG. 2. The learning resource generation system 136 accesses text data in one or more target languages, generates language units, computes scores associated with the language units, and generates relationship instances representing relationships between select language units, as further described below. The language learning application 112 accesses the generated language units, scores, and relationship instances via an API or via direct database queries to retrieve educational data assets for presentation to users.

The application server 108 is communicatively coupled to one or more database server(s) 124, which facilitate access to one or more database(s) 126 storing data associated with data generated or processed by client applications 102 and 104 and one or more applications and subsystems of server system 122. In some examples, one or more of the database(s) 126 are used to store educational data assets, including language units, scores associated with the language units, and relationship instances, as further described at least in relation to FIG. 2 below. The database(s) 126 can include at least a relational database (e.g., a SQL database), a non-tabular database (e.g., a NoSQL database), or a database of another type.

FIG. 2 is a block diagram illustrating a learning resource generation system 136, according to some examples. The learning resource generation system 136 may include one or more of at least a text processing component 210, a corpus-based modeling component 212, and a data augmentation component 214.

The learning resource generation system 136 takes as input one or more corpora 204, 206, 208, and so forth. In an illustrative example, corpus 204 may correspond to a set of documents (e.g., conversation transcripts) in a target language of interest (e.g., Armenian, French, Spanish, Swahili, Mandarin). In some examples, corpus 204 may correspond to a multi-lingual corpus (e.g., a parallel corpus).

Given example corpus 204, the text processing component 210 implements one or more text analysis, processing, or filtering operations on corpus 204 to generate different types of language units (see further below) and/or processed versions of corpus 204. For example, text processing component 210 applies one or more of a language detection module, a tokenization module, a module for detecting multiple word expressions (MWEs), a lemmatization module, a part-of-speech (POS) tagger, a module for detecting morphology and/or grammatical markers, or one or more parser modules producing parses for sentences and/or utterances in the corpus (e.g., constituency parses, syntactic dependency parses such as universal dependency parses following the Universal Dependencies formalism). In some examples, the text processing component 210 applies a profanity detection and/or filtering module. In some examples, text processing component 210 runs an automatic machine translation (MT) pipeline to translate target language utterances in corpus 204 to corresponding utterances in an instruction language (e.g., English). In this manner, corpus 204 may be augmented or transformed from a target language corpus to a corpus containing target language utterances together with corresponding instruction language utterances.

In some examples, the text processing component 210 uses one or more dictionaries as part of the MT pipeline to automatically translate words or phrases, while machine learning models (e.g., neural machine translation models) may be used to translate entire utterances. While English is used as an illustrative example of an instruction language throughout this disclosure, the systems and methods disclosed herein function similarly for other target language-instruction language pairs (e.g., French and Spanish). In some examples, corpus 204 is a parallel corpus, containing a set of utterances in a target language together with corresponding content in the instruction language. In such cases, the machine translation operation may be skipped.

In some examples, the text processing component 210 uses one or more natural language processing (NLP) pipelines, libraries, or APIs, such as Stanza, spaCy, Natural Language Toolkit (NLTK), AllenNLP, Google Cloud Natural Language API, Google Cloud Translation API, Amazon Comprehend, Amazon Translate, Microsoft Azure Text Analytics, Microsoft Translator, Marian NMT, OpenNMT, Moses, Fairseq, DeepL API, or Helsinki-NLP, among others.

Language Units: Using the text processing component 210, the learning resource generation system 136 generates language units, where language units broadly refer, for the purposes of this disclosure, to tokens (e.g., word forms), lemmas (e.g., word roots), phrases, utterances (e.g., corpus sentences or sentence fragments), and grammatical representations of utterances (e.g., linearized parses). In some examples, the learning resource generation system 136 further augments language units such as tokens or lemmas with additional information (e.g., lexical definitions) by accessing and/or processing dictionaries or lexical information resources (e.g., Wiktionary).

Given corpus 204 and/or one or more processed versions of corpus 204 as described above, corpus-based modeling component 212 automatically derives characteristics associated with the original corpus 204, its processed versions, and/or automatically generated language units. For example, the corpus-based modeling component 212 computes corpus-level language models (LMs) using a set of machine learning models, such as text-based language models and/or language models based on generated grammatical representations or grammar structures (e.g., delexicalized parses of utterances). The corpus-based modeling component 212 computes corpus-specific text-based LMs and grammar-based LMs using the target language utterances and/or the corresponding instruction language utterances. The corpus-based modeling component 212 uses the one or more computed LMs as well as additional generated corpus statistics to compute one or more scores associated with language units in corpus 204, such as a salience score, a complexity score, a perplexity score, or a frequency score, and ranks the language units based on their associated scores for downstream use.

In some examples, a salience score for a language unit is computed based on a frequency of occurrence of the language unit in corpus 204 relative to a distribution of other language units, such that language units appearing in characteristic contexts receive higher salience scores. In some examples, a complexity score for a language unit is computed based on one or more of a length of the language unit, a depth of a grammatical parse associated with the language unit, or a perplexity score of the language unit under a computed language model. In some examples, a perplexity score for an utterance is computed as a function of a probability assigned to the utterance by a language model trained or estimated on corpus 204 or on a processed version of corpus 204. In some examples, the learning resource generation system 136 retains utterances with top K lowest perplexity scores (or with perplexity scores lower than a threshold), which may correspond to more understandable or more predictable utterances in the context of corpus 204 and a computed text-based LM. In some examples, the learning resource generation system 136 ranks utterances based on their perplexity score in the context of a processed version of corpus 204 and an estimated LM based on grammar structures or representations for corpus utterances. Ranking utterances and other language units based on perplexity scores and other complexity scores is useful for downstream uses, such as identifying a progression of simple-to-complex examples to be presented to users in the context of language learning application 112.

Given language units of interest such as tokens, lemmas, phrases, and/or utterances in corpus 204, the corpus-based modeling component 212 also generates corresponding feature vectors (e.g., embeddings) and clusters the corresponding language units based on their feature vectors and one or more clustering algorithms. Clusters may be directly displayed (e.g., by language learning application 112) or used to derive similarity, relatedness, or other types of relationships characterizing pairs or tuples of language units of interest. For example, the corpus-based modeling component 212 computes and stores, for a target language phrase, a set of N most related target language phrases (e.g., based on semantic similarity or similarity of grammatical structure). In some examples, the feature vectors (e.g., embeddings) are computed based on the given corpus using an embedding model trained on at least a portion of the corpus. In some examples, the feature vectors include embedding information derived from pre-computed representations (e.g., pre-trained embeddings). In some examples, the corpus-based modeling component 212 determines semantic similarity between language units by computing a distance metric (e.g., a cosine distance, a Euclidean distance) between the corresponding feature vectors. In some examples, the corpus-based modeling component 212 determines grammatical structure similarity between utterances by comparing linearized parse representations of the utterances, by computing a distance metric between feature vectors derived from the linearized parse representations, or a combination thereof. In some examples, the corpus-based modeling component 212 implements one or more of the above operations using data sources, libraries, or pipelines such as KenLM, fastText, SentenceTransformers, BERT embeddings, ModernBERT Embed embeddings, OpenAI API text embeddings, or Gemini API text embeddings, among others.

In some examples, the learning resource generation system 136 includes a data augmentation component 214 that is used in conjunction with the text processing component 210 and/or corpus-based modeling component 212. For example, the data augmentation component 214 augments the feature space for language units of interest in corpus 204 using pre-trained embeddings.

Language Unit Relationships: As noted above, the learning resource generation system 136 instantiates one or more predetermined relationships among language units and generates new associations involving the generated language units (e.g., via clustering and/or other data mining operations), producing relationship instances representing relationships between select language units. In addition to lexical or semantic similarity/relatedness and grammatical structure-based similarity/relatedness, relationships (including attributes) may include a translation relationship, a lexical definition relationship, and a usage example relationship (e.g., between a first language unit and a second language unit in which the first language unit appears). In some examples, the learning resource generation system 136 combines relationship instances and unit-level scores to derive sequences of language units for instruction purposes. For example, the learning resource generation system 136 generates sequences of paraphrases for an utterance or phrase, where the sequences are ordered based on complexity scores or perplexity scores. As discussed further in the disclosure, the learning resource generation system 136 may be used in conjunction with (or may include) an interactive language learning application 112 that incorporates speech recognition/transcription and text-to-speech capabilities. In this context, the learning resource generation system 136 further automatically relates language units with similar pronunciation patterns or sound structures, or language units that share common vocalization markers or clitics. As noted above, corpus 204 and other corpora may include conversational content, in which case the learning resource generation system 136 extracts pairs or tuples of utterances that commonly occur in sequence during conversations and/or identifies turn-taking patterns or response relationships in dialogues. Relationship instances generated by the learning resource generation system 136 may be focused on a specific domain or topic or may be open domain. In some examples, the learning resource generation system 136 receives user interaction data (e.g., engagement statistics) tracked by the language learning application 112, the user interaction data being associated with presented language units, relationships between language units, and other data assets. The learning resource generation system 136 uses the received user interaction data to derive or augment relationship instances among the presented language units.

As described above, the learning resource generation system 136 automatically generates educational resources and data assets that are stored in and later retrieved from data assets 216. In some examples, accessing data assets 216 is performed via an application programming interface (API). For instance, the data assets 216 component employs a JSON Object Schema as exemplified below for sentence, lemma, and token language units in the context of computed or generated attribute information for each language unit (e.g., corpus statistics, translation information):
SentenceSchema={“type”: “object”, “title”: LangGuru Sentence”, “description”: “Object representing a sentence. May be decorated with linguistic analysis and translations”, “properties”: {“sent_id”: {“type”: “number”}, “lang”: {“type”: “string”}, “corpus”: {“type”: “string”}, “split”: {“type”: “string”}, “sentence_text”: {“type”: “string”}, “text_score”: {“type”: “number”}, #float “grammar”: {“type”: “string”}, “grammar_score”: {“type”: “number”}, #float “num_similar_sentences”: {“type”: “number”}, “translation_text”: {“type”: “string”}, “translation_lang”: {“type”: “string”},} “required”: [“lang”, “sentence_text”],}
LemmaSchema={“type”: “object”, “title”: “LangGuru Lemma”, “description”: “Object representing a lemma (root word form)”, “properties”: {“lang”: {“type”: “string”}, “corpus”: {“type”: “string”}, “split”: {“type”: “string”}, “lemma_text”: {“type”: “string”}, “upos”: {“type”: “string”}, “corpus_count”: {“type”: “number”}, “corpus_percent”: {“type”: “number”}, “translation_lang”: {“type”: “string”}, “top_translation”: {“type”: “string”}, “cluster”: {“type”: “number”}, “wiktionary_translations”: {“type”: “array”, “items”: {“type”: “string”},}, “reverso_translations”: {“type”: “array”, “items”: {“type”: “string”},}, “model_translations”: {“type”: “array”, “items”: {“type”: “string”},}, “examples”: {“type”: “array”, “description”: “array of Sentence objects, to be recursively validated”, “items”: {“type”: “object”},}, “related”: {“type”: “array”, “description”: “array of Lemma objects, to be recursively validated”, “items”: {“type”: “object”},},}, “required”: [“lang”, “lemma_text”, “upos”],}
TokenSchema={“type”: “object”, “title”: “LangGuru Token”, “description”: “Object representing a token (a specific word form).”, “properties”: {“lang”: {“type”: “string”}, “corpus”: {“type”: “string”}, “split”: {“type”: “string”}, “token_text”: {“type”: “string”}, “upos”: {“type”: “string”}, “lemma_text”: {“type”: “string”}, “features”: {“type”: “string”}, “feat_prevalence”: {“type”: “number”}, “corpus_count”: {“type”: “number”}, “examples”: {“type”: “array”, “description”: “array of Sentence objects, to be recursively validated”, “items”: {“type”: “object”},},}, “required”: [“lang”, “token_text”, “lemma_text”, “upos”]}.

In some examples, the data assets 216 API can be used by the language learning application 112 to retrieve educational data assets for further presentation and interaction purposes, as described in at least FIG. 5-FIG. 10. Example API functions can include, among others:
GET/langs—Get supported languages
GET/topn—Get top N words by part of speech (POS)
GET/top_with_cutoff—Get top words (e.g., lemmas, etc.) with cutoff by POS, with usage examples
GET/get_lemma_examples—Get usage examples for a lemma
GET/get_token_examples—Get usage examples for a specific token
GET/find_similar_sentences—Find sentences with similar grammatical structure
GET/find_related_lemmas—Find semantically related lemmas
GET/get_foundational_sentences—Get foundational sentences (for a particular target language)

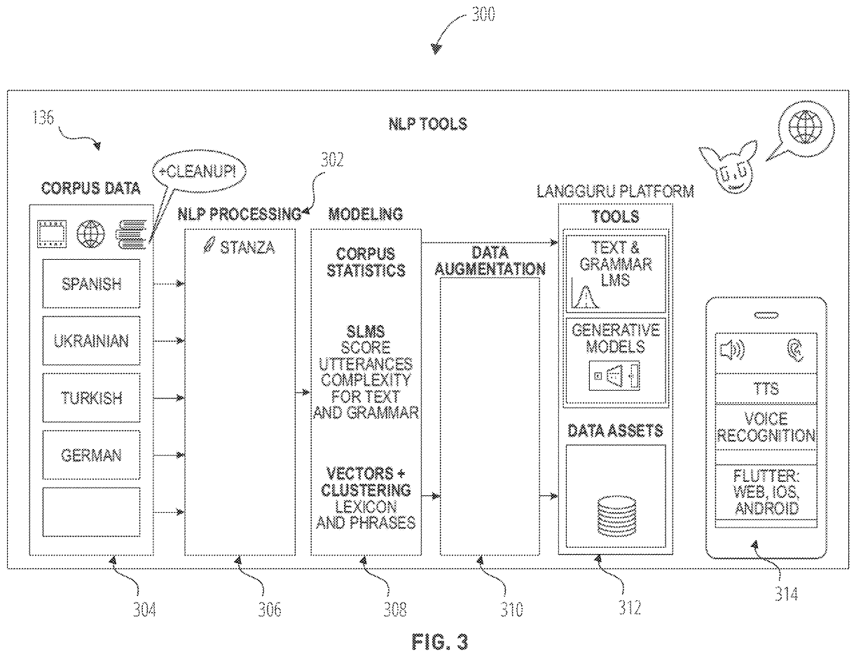

FIG. 3 is a block diagram illustrating a view 300 of a learning resource generation system 136, according to some examples. In the FIG. 3 example, the learning resource generation system 136 processes corpus data 304 for one or more target languages (e.g., Spanish, Ukrainian, Turkish, German, and other target languages). The learning resource generation system 136 illustrated in FIG. 3 uses an NLP library 302 (e.g., Stanza, among others), for example as part of the text processing component 210 as described in FIG. 2, to perform NLP processing 306 on the corpus data 304 and generate and annotate language units of interest, such as utterances, phrases, tokens, lemmas, and grammatical representations of utterances.

In some examples, the learning resource generation system 136 of FIG. 3 performs modeling 308 on the processed corpus data as part of, or in conjunction with, the corpus-based modeling component 212 of FIG. 2. The modeling 308 may include training or estimating language models on the corpus data, including text-based language models and grammar-based language models, and may further include computing utterance-level complexity scores, corpus statistics for language units, and feature vectors for select language units. The feature vectors may be used to compute clusters and/or relationship instances among language units. The learning resource generation system 136 of FIG. 3 further performs data augmentation 310, which may incorporate one or more of generative models, text-to-speech (TTS) functionality, and voice recognition functionality to augment the generated language units and associated data.

Based on the modeling 308 and data augmentation 310 outputs, the learning resource generation system 136 generates data assets 312 for the one or more target languages (e.g., corresponding to, or including, data assets 216 of FIG. 2). The data assets 312 may include a set of representative utterances or sentences, a lexicon of key phrases, and one or more sets of relationship instances for relationships of predetermined types. The data assets 312 are accessible to a client application 314 (e.g., a cross-platform client application implemented for web, iOS, and/or Android environments), which in some examples corresponds to client application 102 or client application 104 of FIG. 1, executing a language learning application 112 as described in FIG. 1 and FIG. 4.

FIG. 4 is a block diagram 400 illustrating a language learning application 112, according to some examples. An example language learning application 112 may include at least a language instruction module 402, a user profile module 404, and a user interface 406. As illustrated in FIG. 4, the language instruction module 402, the user profile module 404, and the user interface 406 are communicatively coupled within the language learning application 112. In some examples, data related to data accessed or generated by the language learning application 112 is stored in one or more database(s) 126, via one or more database server(s) 124 (e.g., corresponding to or including data assets 216). In some examples, language learning application 112 may be implemented as a web application or a mobile application. Language Instruction Module: The language learning application 112 may include a language instruction module 402 that selects and/or presents language learning units (e.g., tokens, lemmas, phrases, utterances, etc.), relationships among the language learning units (e.g., phrase similarity, semantic similarity of lemmas, example of token or lemma usage, etc.), and other educational resources or assets, via an example user interface 406 rendered and displayed by a client application 102 at client device 118 or client application 104 at client device 120. Automatically detected selections of user-selectable interface elements from the UI associated with the language instruction module 402 are used by the language learning application 112 to enable navigation through the educational resources and/or assets. For example, language learning application 112 implements functions and technologies for enabling a user to navigate through, and interact with, the set of educational resources for language learning as seen at least in FIG. 5 to FIG. 12.

In some examples, the language instruction module 402 may retrieve and/or present games, tests, translation exercises, and so forth, for automatically eliciting and/or evaluating the progress and/or knowledge of a user. In some examples, the automatic evaluation of the user can rely on language units, language unit relationships, and so forth. For example, the language instruction module 402 may use translation exercises intended to elicit speech generation from the learner—in such a scenario, the learner's responses may be automatically evaluated based on their grammaticality and semantic similarity to the expected target language phrases.

User Profile Module: In some examples, language learning application 112 may include a user profile module 404 that stores, tracks, and/or displays profile data for a user, as well as data related to a user's progress through and engagement with presented educational data assets for language learning. User profile information may include user log-in or contact information, currently selected (or default) preferences with respect to the desired language learning experience, engagement data, progress data and/or completion data with respect to presented educational resources, explicitly declared study goals (see, e.g., at least FIG. 5), and so forth. In some examples, data related to data accessed or generated by the language learning application 112 is processed by the data processing system 128 and is stored in, retrieved from, or updated using one or more database(s) 126, via one or more database server(s) 124.

For instance, one or more database(s) 126 (e.g., corresponding to, or including, data assets 216) may store language learning units for one or more target languages (e.g., tokens, lemmas, phrases, utterances, and so forth, augmented with at least statistical, semantic, and/or grammatical information), relationships among the language learning units (e.g., similarity, relatedness, etc.), and other educational content information for the one or more target languages of interest. In some examples, the one or more database(s) 126 may store regularly updated user profile, progress, and engagement data for a set of users, as well as regularly updated engagement and/or progress information for language learning units, unit relationships, and/or other educational content information. For example, the language learning application 112 may track time spent per language learning unit and/or other interaction or engagement statistics to identify units that may be difficult to understand or may need additional information/usage examples, and so forth.

FIG. 5 is an illustration of an example UI 500 displayed in connection with language learning application 112, according to some examples. Example UI 500 may include UI elements (including user-selectable elements) for configuring and/or enabling the customization of a user's language learning experience for a selected target language.

As illustrated in FIG. 5, example UI 500 may include a target language selector 502 configured to enable selection of a target language of interest (e.g., French, Spanish, Swahili, Mandarin, and so forth). Example UI 500 may further include a competence level selector 504 configured to enable selection of a user proficiency level (e.g., Beginner, Intermediate, Advanced, and so forth) with respect to the selected target language. Example UI 500 may further include a study set size selector 506 configured to enable selection of a number of language learning units to be included in a study set (e.g., 12, or another user-specified or default value).

Example UI 500 may further include one or more user-selectable elements for configuring presentation preferences, such as a user-selectable element 508 configured to enable or disable automatic audio playback of newly presented phrases (e.g., via text-to-speech functionality), and a user-selectable element 510 configured to enable or disable the presentation of content associated with one or more content categories (e.g., informal language, idiomatic expressions, and so forth). Example UI 500 may further include a user-selectable element 512 (e.g., labeled “Save Changes”) configured to cause persistence of the user-specified configuration preferences (e.g., in user profile module 404 of FIG. 4), and a user-selectable element 514 (e.g., labeled “Dismiss”) configured to cause closure of the UI 500 without persisting changes.

In some examples, the configuration preferences received via example UI 500 may be used by the language learning application 112 to customize subsequent presentation of language learning units and associated educational resources to the user. Example UI elements in FIG. 5 may be displayed as part of the same window, page, panel, or other display element. Alternatively, they may be displayed separately, either at the same time or sequentially (e.g., based on a series of user interactions with language learning application 112). Example UI elements may also be displayed as part of one or more pop-up displays, or in other UI configurations. Similar display considerations apply to UI elements throughout the other UI examples in the disclosure herein.

FIG. 6 is an illustration of an example UI 600 displayed in connection with language learning application 112, according to some examples. Example UI 600 may include a plurality of user-selectable UI elements, each corresponding to a respective unit type of a plurality of unit types that may be selected for study.

As illustrated in FIG. 6, example UI 600 may include a user-selectable element 602 corresponding to a first unit type (e.g., foundational units such as conversation essentials), a user-selectable element 604 corresponding to a second unit type (e.g., verbs), a user-selectable element 606 corresponding to a third unit type (e.g., nouns), a user-selectable element 608 corresponding to a fourth unit type (e.g., adjectives), and a user-selectable element 610 corresponding to a fifth unit type (e.g., adverbs). Each of the user-selectable elements 602, 604, 606, 608, 610 may be displayed together with a respective descriptor, tagline, or iconographic representation that identifies the associated unit type.

Example UI 600 may further include a target language indicator 612 identifying the currently selected target language (e.g., French, or another target language previously selected by the user, for example via target language selector 502 of FIG. 5). In response to detecting a selection of one of the user-selectable elements 602, 604, 606, 608, 610 (e.g., via a click, tap, or other user input), the language learning application 112 causes display of a follow-up page, screen, or panel (see, e.g., at least FIG. 7) that presents units of the selected unit type and enables further user interaction with the units of the selected unit type.

Although FIG. 6 illustrates five user-selectable elements corresponding to five respective unit types, it will be appreciated that example UI 600 may include fewer or additional user-selectable elements corresponding to fewer or additional unit types (e.g., pronouns, prepositions, conjunctions, interjections, phrases, idioms, and so forth), depending on the target language and/or user configuration.

FIG. 7 is an illustration of an example UI 700 displayed in connection with language learning application 112, according to some examples. Example UI 700 may be displayed responsive to detecting a selection of a user-selectable element corresponding to a unit type (e.g., user-selectable element 604 for verbs, as described with reference to FIG. 6). As illustrated in FIG. 7, example UI 700 may include a ranked list 710 of lemma entries (e.g., verbs), where the lemma entries correspond to language units generated by the learning resource generation system 136 for the selected target language and selected unit type. Each lemma entry in the ranked list 710 may include a ranking indicator (e.g., a position number reflecting relative salience, frequency, or another computed score), the lemma itself (e.g., “dire,” “vouloir,” “prendre,” “savoir,” “voir,” and so forth in the illustrated French example), and one or more associated lexical definitions or translations to the instruction language (e.g., English).

In response to detecting a selection of a lemma entry 708 (e.g., corresponding to the lemma “savoir”) from the ranked list 710, the language learning application 112 causes display of a set 712 of example utterances associated with the selected lemma. The set 712 of example utterances may include target language utterances (e.g., “Je sais,” “Je ne sais pas,” “Tu sais quoi?” “Je le sais,” “Oui, je sais,” “Je le savais,” and so forth) retrieved from the data assets (e.g., data assets 216 of FIG. 2) based on one or more of the selected lemma, associated scores, and relationship instances. Each example utterance in the set 712 may be displayed together with a corresponding translation to the instruction language. In some examples, one or more of the tokens within each example utterance displayed in set 712 may be individually user-selectable.

In response to detecting a user selection of a user-selectable token (e.g., the token “sais” within the utterance “Je sais”), the language learning application 112 causes display of a panel, overlay, or other UI element presenting token-level information associated with the selected token. The token-level information may include, for example, the selected token itself, the corresponding lemma (e.g., “savoir”) from which the token is derived, a part-of-speech indicator (e.g., verb), one or more grammatical features associated with the selected token (e.g., mood, number, person, tense, verb form, or other morphological features output by a parser as described with reference to FIG. 2), and one or more possible meanings or translations of the corresponding lemma in the instruction language. The token-level information displayed responsive to the token selection may be retrieved from the data assets 216 based on the parsed and annotated unit data generated by text processing component 210 of FIG. 2.

Example UI 700 may further include, in association with one or more of the example utterances in set 712, a user-selectable element 702 configured to, upon selection, cause display of a follow-up panel or screen enabling the user to further explore the selected utterance, associated language units, and related resources (see, e.g., at least FIG. 9). Example UI 700 may further include, in association with one or more of the example utterances, a user-selectable element 704 configured to, upon selection, cause removal of the corresponding example utterance from a study set, and a user-selectable element 706 configured to, upon selection, cause addition of the corresponding example utterance to the study set.

The study set may be managed, for example, by the user profile module 404 of FIG. 4 and may be used in subsequent interactive study sessions. Example UI 700 may further include a target language indicator 714 identifying the currently selected target language, and a study set status indicator 716 identifying a current state of the study set (e.g., a number of language units currently included in the study set relative to a maximum study set size configured via UI 500 of FIG. 5).

FIG. 8 is an illustration of an example UI 800 displayed in connection with language learning application 112, according to some examples. Example UI 800 may be displayed, for example, responsive to detecting a selection of user-selectable element 702 described with reference to FIG. 6, or in response to another user interaction selecting a language unit for further exploration. Example UI 800 may include a display region 806 presenting a currently explored language unit (e.g., the utterance “Je sais” and its corresponding translation “I know” in the illustrated French example). The currently explored language unit may correspond to one of the language units generated and stored by the learning resource generation system 136 of FIG. 2.

Example UI 800 may further include a plurality of user-selectable elements each corresponding to a different type of relationship involving the currently explored language unit, where the relationships are among those populated by the learning resource generation system 136 as described with reference to FIG. 2. For example, user-selectable element 802 may be configured to, upon selection, cause retrieval and display of a set 808 of phrases having a grammatical structure similarity relationship with the currently explored language unit. In the illustrated example, in response to detecting user selection of user-selectable element 802 while “Je sais” is the currently explored utterance, the language learning application 112 retrieves from the data assets 216 of FIG. 2 a set 808 of phrases that share a similar grammatical structure with “Je sais” (e.g., “J'arrive,” “Je reviens,” “Je vois,” and so forth). Each phrase in the set 808 may be displayed together with a corresponding translation to the instruction language.

In some examples, each phrase in the set 808 may be displayed in association with a user-selectable audio playback element 810 that, upon selection, causes presentation of audio corresponding to a vocalization of the phrase in the target language. The audio may be generated by a text-to-speech (TTS) component and/or retrieved from the data assets 216. Example UI 800 may further include one or more other user-selectable elements (e.g., user-selectable element 804) each configured to, upon selection, cause retrieval and display of another type of language learning resource or relationship instance associated with the currently explored language unit. For example, user-selectable element 804 may correspond to display of pronunciation or vocalization resources, display of token-level or lemma-level usage examples, display of semantic relationship instances (see, e.g., FIG. 8 further below), or another relationship type populated by the learning resource generation system 136.

Example UI 800 may further include navigation controls 812 (e.g., Previous and Next controls) configured to, upon selection, cause the language learning application 112 to navigate to a preceding or subsequent language unit in a current sequence (e.g., the next utterance associated with a currently selected lemma, a next item in a study set, or the like). Example UI 800 may further include a target language indicator 814 identifying the currently selected target language, and a study set status indicator 816 identifying a current state of the study set being constructed or reviewed by the user.

FIG. 9 is a flowchart illustrating a method 900 for automatically generating language learning resources, according to some examples. Method 900 may be performed by a system, such as system 100 of FIG. 1, operating in conjunction with the learning resource generation system 136 of FIG. 2.

At operation 902, the learning resource generation system 136 accesses text data. In some examples, the text data comprises one or more conversations in a target language. The text data may be accessed from one or more corpora, such as corpus 204, corpus 206, or corpus 208 of FIG. 2. In some examples, the text data comprises a parallel corpus containing utterances in the target language together with corresponding utterances in an instruction language.

At operation 904, the learning resource generation system 136 processes the text data using one or more text analysis models. Processing the text data may be performed by the text processing component 210 of FIG. 2 and may include applying at least one of: a language detection operation, a tokenization operation, a lemmatization operation, a part-of-speech tagging operation, a morphological analysis operation, a dependency parsing operation, a multi-word expression detection operation, a profanity detection and filtering operation, or a machine translation operation from the target language to an instruction language. Processing the text data generates processed text data and a plurality of language units. The plurality of language units may comprise one or more of tokens, lemmas, phrases, utterances, or grammatical representations of utterances (e.g., linearized dependency parses).

At operation 906, the learning resource generation system 136 computes, based at least in part on the processed text data, one or more scores associated with the language units. Score computation may be performed by the corpus-based modeling component 212 of FIG. 2 using a set of machine learning (ML) models. The one or more scores may comprise at least one of a salience score, a complexity score, a perplexity score, or a frequency score. In some examples, computing the one or more scores comprises training or estimating one or more corpus-specific language models based at least in part on the processed text data, and computing a perplexity score for a language unit based on the one or more corpus-specific language models. In some examples, the one or more corpus-specific language models comprise a text-based language model estimated based on utterances in the target language and a grammar-based language model estimated based on grammatical representations of the utterances.

At operation 908, the learning resource generation system 136 generates, based at least in part on the processed text data, one or more relationship instances representing relationships between select language units of the plurality of language units. The relationships may comprise at least one of a semantic similarity relationship, a grammatical structure similarity relationship, a translation relationship, a lexical definition relationship, or a usage example relationship. In some examples, generating a relationship instance comprises computing feature vectors for at least a portion of the language units (e.g., using one or more of a pre-trained embedding model or an embedding model trained on at least a portion of the text data) and determining the relationship instance based at least in part on the feature vectors (e.g., based on a cosine similarity or another distance metric computed between feature vectors).

At operation 910, the learning resource generation system 136 stores the generated language units, the one or more scores, and the one or more relationship instances. The generated language units, scores, and relationship instances may be stored as data assets 216 of FIG. 2 in one or more databases, such as databases 126 of FIG. 1. In some examples, the stored data assets are accessible via an application programming interface (API).

At operation 912, a computing device (e.g., client device 118 or client device 120 of FIG. 1) detects, via a user interface (UI) associated with a language learning application 112, a selection of a user-selectable element. The user-selectable element may be configured to enable selection of a unit type from a plurality of unit types (e.g., token, lemma, phrase, utterance), a selection of a relationship type from a plurality of relationship types, or another selection.

At operation 914, the language learning application 112 retrieves a subset of the generated language units from the stored data assets. Retrieval may be based on one or more of: the selected unit type, the one or more scores, the one or more relationship instances, or one or more user preferences. In some examples, retrieval comprises ranking candidate language units based on the one or more scores and selecting a predetermined number of top-ranked language units.

At operation 916, the language learning application 112 causes display of the retrieved subset of the language units in the UI of the computing device. In some examples, each displayed language unit is presented in association with one or more user-selectable elements configured to enable further user interaction with the language unit, including at least one of: selection of the language unit for addition to a study set, selection of the language unit for further exploration, or selection of a relationship instance associated with the language unit.

FIG. 10 is a flowchart illustrating a method 1000 for constructing and presenting an interactive language study session, according to some examples. Method 1000 may be performed by a system, such as system 100 of FIG. 1, operating in conjunction with the language learning application 112, the learning resource generation system 136, and the data assets 216.

At operation 1002, the language learning application 112 retrieves, from the data assets 216, a set of candidate language units based on a target language and one or more user preferences received via a UI of a computing device. The one or more user preferences may include at least one of a proficiency level, a study set size, a domain of interest, or another user preference. Retrieval may be further based on one or more scores associated with the candidate language units, including at least one of a salience score or a complexity score.

At operation 1004, the language learning application 112 causes display, in the UI, of the retrieved set of candidate language units. In some examples, each displayed candidate language unit is presented in association with one or more user-selectable elements configured to enable the user to add or remove the candidate language unit from a study set, or to further explore the candidate language unit.

At operation 1006, the language learning application 112 constructs a study set comprising language units selected via the UI from the displayed set of candidate language units. The study set may be associated with a user profile maintained by the user profile module 404 of FIG. 4 and stored in the one or more databases 126 of FIG. 1.

At operation 1008, the language learning application 112 generates an interactive session based on the study set and based on an interactive mode selected via the UI from a plurality of interactive modes. The plurality of interactive modes may include at least one of a matching mode, an audio playback mode, a reading mode in which language units are displayed in the target language without translations, a translation-only mode in which language units are displayed in an instruction language without the target language, or another interactive mode. Generating the interactive session may include selecting an ordering of language units from the study set and generating associated multimedia content, such as audio content generated via a text-to-speech component.

At operation 1010, the language learning application 112 presents, via the UI, the interactive session. Presenting the interactive session may include sequentially displaying language units from the study set, presenting audio corresponding to the language units, displaying user-selectable elements enabling user responses, or a combination thereof.

At operation 1012, the language learning application 112 stores, in association with a user profile, one or more session metrics computed based on user interaction data received via the UI during the interactive session. The user interaction data may include at least one of user selections of user-selectable elements, timing information, correctness indicators, or navigation events. The session metrics may include at least one of an accuracy score, a completion percentage, a timing metric, or another metric characterizing user performance during the interactive session. The stored session metrics may be used to inform subsequent retrieval of candidate language units, to update the user profile, or to inform regeneration of relationship instances by the learning resource generation system 136.

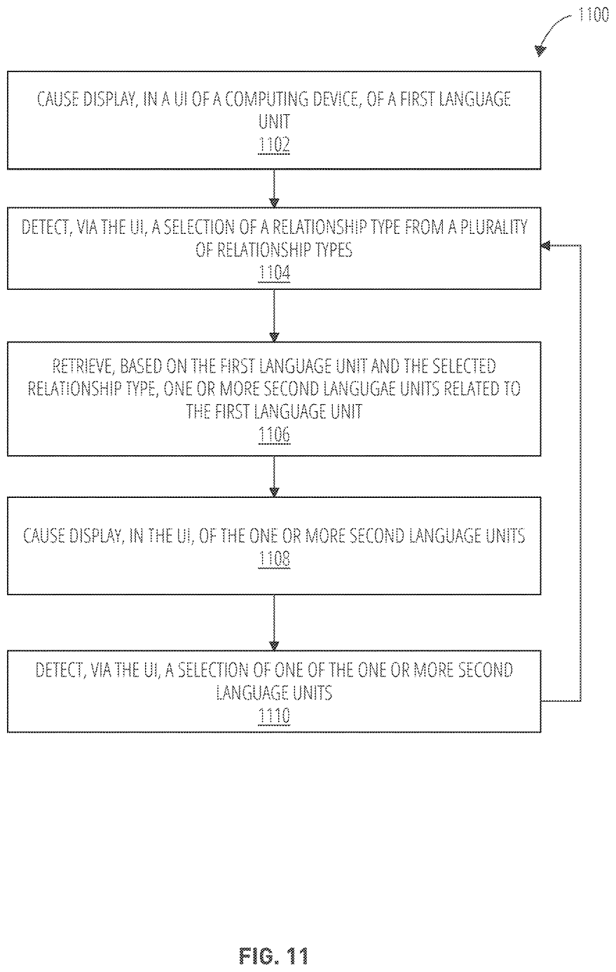

FIG. 11 is a flowchart illustrating a method 1100 for relationship-based exploration of language units, according to some examples. Method 1100 may be performed by a system, such as system 100 of FIG. 1, operating in conjunction with the language learning application 112 of FIG. 4 and the data assets 216 of FIG. 2.

At operation 1102, the language learning application 112 causes display, in a user interface (UI) of a computing device (e.g., client device 118 or client device 120 of FIG. 1), of a first language unit. The first language unit may be retrieved from the data assets 216 based on one or more user preferences, one or more scores associated with the first language unit, a prior user selection, or a combination thereof. The first language unit may comprise one of a token, a lemma, a phrase, an utterance, or a grammatical representation of an utterance.

At operation 1104, the language learning application 112 detects, via the UI, a selection of a relationship type from a plurality of relationship types. The plurality of relationship types may comprise at least one of: a semantic similarity relationship, a grammatical structure similarity relationship, a translation relationship, a lexical definition relationship, a usage example relationship, or another relationship type. Detection may be performed responsive to a user selecting a user-selectable element associated with the relationship type in the UI.

At operation 1106, the language learning application 112 retrieves, from the data assets 216, one or more second language units related to the first language unit based on the selected relationship type. Retrieval is based on one or more relationship instances previously generated by the learning resource generation system 136 (e.g., as described in operation 908 of FIG. 9) and stored as part of the data assets 216. In some examples, retrieving the one or more second language units comprises ranking candidate second language units based on one or more of: a similarity score associated with the relationship instance, a salience score associated with the candidate second language unit, or a complexity score associated with the candidate second language unit.

At operation 1108, the language learning application 112 causes display, in the UI, of the one or more second language units. Each displayed second language unit may be presented in association with one or more user-selectable elements configured to enable further user interaction, including at least one of: selection of the second language unit for addition to a study set, selection of the second language unit as a new first language unit for further exploration, or selection of an additional relationship type associated with the second language unit.

At operation 1110, the language learning application 112 detects, via the UI, a selection of one of the one or more second language units. Responsive to the detected selection, method 1100 may return to operation 1102, with the selected second language unit treated as a new first language unit, thereby enabling iterative exploration of language unit relationships. In some examples, iterative exploration enables a user to traverse a graph of language units connected by one or more relationship instances, with each traversal informed by a user-selected relationship type.

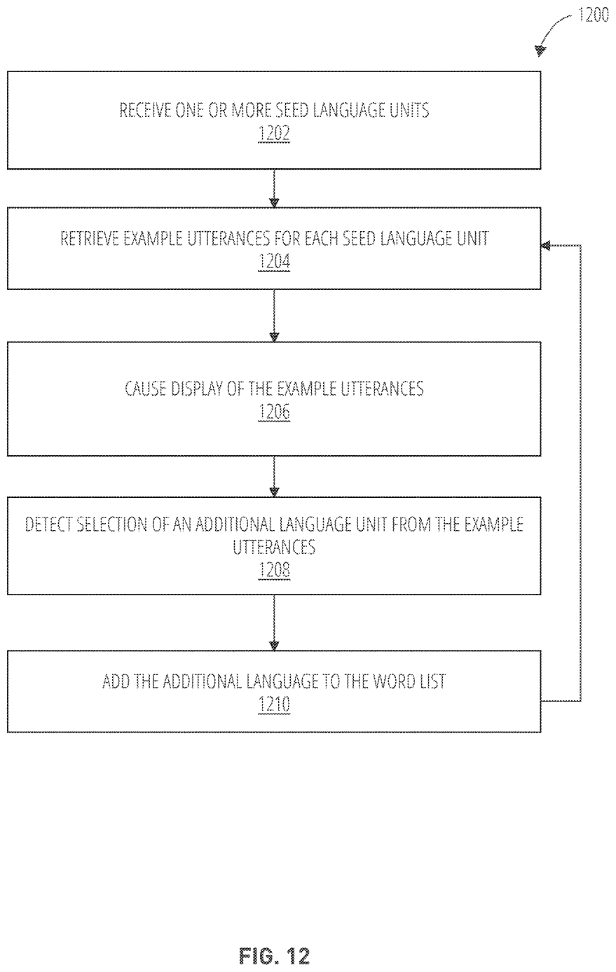

FIG. 12 is a flowchart illustrating a method 1200 for constructing a word list based on one or more seed language units, according to some examples. Method 1200 may be performed by a system, such as system 100 of FIG. 1, operating in conjunction with the language learning application 112 of FIG. 4 and the data assets 216 of FIG. 2.

At operation 1202, the language learning application 112 receives, via a UI of a computing device, one or more seed language units. A seed language unit may comprise a token, a lemma, or a phrase provided by a user. In some examples, the seed language unit is provided in a surface form, and the language learning application 112 identifies a corresponding lemma based on the data assets 216.

At operation 1204, the language learning application 112 retrieves, from the data assets 216, one or more example utterances for each seed language unit. Retrieval may be based on one or more usage example relationships between the seed language unit and utterances in a corpus (e.g., as generated by the learning resource generation system 136 in FIG. 9). Retrieved example utterances may be ranked based on one or more of: a salience score, a complexity score, or a perplexity score computed during resource generation.

At operation 1206, the language learning application 112 causes display, in the UI, of the example utterances. Each displayed example utterance may include one or more user-selectable elements associated with individual language units within the utterance. At operation 1208, the language learning application 112 detects, via the UI, a selection of an additional language unit appearing in one of the displayed example utterances. The additional language unit may comprise a token, lemma, or phrase within the example utterance.

At operation 1210, the language learning application 112 adds the additional language unit to a word list associated with a user profile. Responsive to the addition, method 1200 may return to operation 1204, with the additional language unit treated as a seed language unit for retrieval of further example utterances. The feedback loop enables iterative construction of a personalized word list, in which each added language unit expands the pool of example utterances available for further exploration.

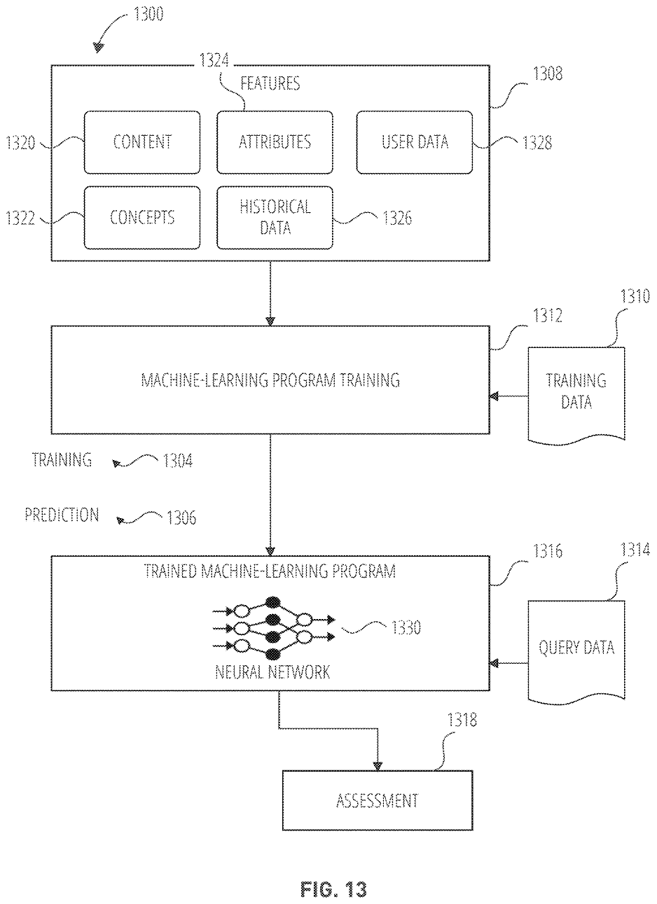

FIG. 13 is a block diagram showing a machine-learning program 1300 according to some examples. The machine-learning program 1300, also referred to as a machine-learning algorithm or tool, is used to train machine-learning models that can be used in connection with one or more operations described herein. For example, one or more machine-learning models trained as described in connection with FIG. 13 may be used by the corpus-based modeling component 212 of FIG. 2 to compute one or more of a perplexity score, a complexity score, a salience score, or a frequency score associated with a language unit; to generate one or more feature vectors or embeddings associated with a language unit; to cluster language units based on associated feature vectors; or to generate a translation of a language unit from a target language to an instruction language.

Machine learning is a field of study that gives computers the ability to learn without being explicitly programmed. Machine-learning tools operate by building a model from example training data 1310 in order to make data-driven predictions or decisions expressed as outputs or assessments (e.g., assessment 1318). Although examples are presented with respect to a few machine-learning tools, the principles presented herein may be applied to other machine-learning tools.

In some examples, the machine-learning program 1300 comprises one or more of a neural network model, an embedding model, a language model, or a transformer-based model. In some examples, the machine-learning program 1300 may be trained using one or more text-based features, grammatical features, or embedding features derived from a text corpus. In some examples, a hierarchy or combination of models (e.g., stacking, bagging) may be used.

The machine-learning program 1300 supports two types of phases, namely a training phase 1304 and a prediction phase 1306. In a training phase 1304, supervised learning, unsupervised learning, or reinforcement learning may be used. For example, the machine-learning program 1300 (1) receives features 1308 (e.g., as structured or labeled data in supervised learning) and/or (2) identifies features 1308 (e.g., unstructured or unlabeled data for unsupervised learning) in training data 1310. In a prediction phase 1306, the machine-learning program 1300 uses the features 1308 for analyzing input or query data 1314 to generate outcomes or predictions, as examples of an assessment 1318.

In the training phase 1304, feature engineering is used to identify features 1308 and may include identifying informative, discriminating, and independent features for the effective operation of the machine-learning program 1300. In some examples, the training data 1310 includes labeled data, which is known data for pre-identified features 1308 and one or more outcomes. Each of the features 1308 may be a variable or attribute represented by a data set (e.g., the training data 1310). Features 1308 may be of different types, such as numeric features, strings, or graphs, and may include one or more of content 1320, concepts 1322, attributes 1324, historical data 1326, or user data 1328, merely for example.

In training phase 1304, the machine-learning program 1300 uses the training data 1310 to find correlations among the features 1308 that affect a predicted outcome or assessment 1318. With the training data 1310 and the identified features 1308, the machine-learning program 1300 is trained during the training phase 1304 at machine-learning program training 1312. The machine-learning program 1300 appraises values of the features 1308 as they correlate to the training data 1310. The result of the training is the trained machine-learning program 1316 (e.g., a trained or learned model).

The trained machine-learning program 1316 may implement a neural network 1330. A neural network 1330 may include a hierarchical (e.g., layered) organization of neurons arranged into a number of layers, including an input layer, an output layer, and one or more hidden layers. The neurons within each layer compute an activation function, and connections between neurons have associated weights, which define the influence of the input from a transmitting neuron to a receiving neuron.

In some examples, the neural network 1330 is one or more of a Recurrent Neural Network (RNN), a Long Short-Term Memory Network (LSTM), a Bidirectional Neural Network, a Convolutional Neural Network (CNN), an Autoencoder Neural Network (AE), or a Transformer Network.

In some examples applicable to language learning resource generation, the machine-learning program 1300 is trained to generate or estimate one or more language models based on a target language corpus. The one or more language models may include a text-based language model estimated from utterances in the target language, a grammar-based language model estimated from grammatical representations of the utterances, or a combination thereof. In some examples, the one or more language models are used to compute a perplexity score associated with a language unit, the perplexity score indicative of a probability of the language unit under the one or more language models.

In further examples, the machine-learning program 1300 is trained to generate embeddings associated with language units. The embeddings may be used to compute similarity scores between language units, to cluster language units into groups of related units, or to populate relationship instances representing at least one of a semantic similarity relationship or a grammatical structure similarity relationship.

During prediction phase 1306, the trained machine-learning program 1316 is used to perform an assessment. Query data 1314 is provided as an input to the trained machine-learning program 1316, and the trained machine-learning program 1316 generates the assessment 1318 as output, responsive to receipt of the query data 1314.

In some examples, the trained machine-learning program 1316 comprises a Large Language Model (LLM). LLMs can perform tasks such as recognizing, translating, predicting, or generating text, and can be used for text classification, question answering, document summarization, or text generation. Examples of LLMs include GPT-3.5, GPT-4, GPT-4o, Gemini, Claude, Llama, Mistral, Cohere, PaLM, Falcon, Orca, Phi, DeepSeek, and others.

In some examples applicable to language learning resource generation, a trained machine-learning program 1316 comprising an LLM is used to generate a translation of a language unit from a target language to an instruction language, or to generate an alternative phrasing or paraphrase of an utterance in the target language.

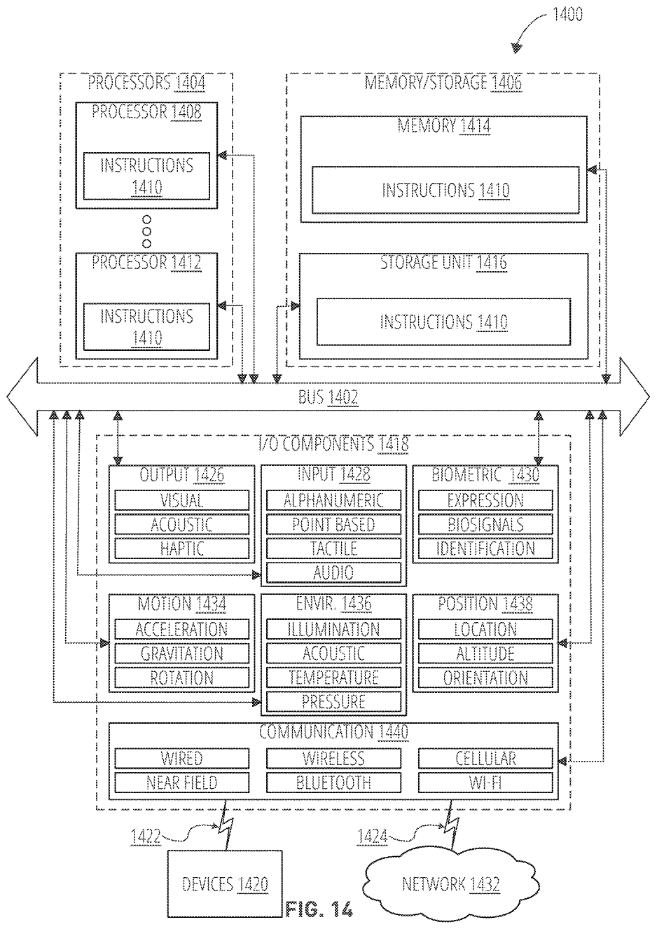

FIG. 14 is a block diagram illustrating components of a machine 1400, according to some examples, able to read instructions from a machine-readable medium (e.g., a machine-readable storage medium) and perform any one or more of the methodologies discussed herein. Specifically, FIG. 14 shows a diagrammatic representation of the machine 1400 in the example form of a computer system, within which instructions 1410 (e.g., software, a program, an application, an applet, an app, or other executable code) for causing the machine 1400 to perform any one or more of the methodologies discussed herein may be executed. As such, the instructions 1410 may be used to implement modules or components described herein. The instructions 1410 transform the general, non-programmed machine 1400 into a particular machine 1400 programmed to carry out the described and illustrated functions in the manner described. In alternative examples, the machine 1400 operates as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment.

The machine 1400 may comprise, but not be limited to, a server computer, a client computer, a personal computer (PC), a tablet computer, a laptop computer, a cellular telephone, a smart phone, a mobile device, a wearable device (e.g., a smart watch), or any machine capable of executing the instructions 1410, sequentially or otherwise, that specify actions to be taken by machine 1400. Further, while only a single machine 1400 is illustrated, the term “machine” shall also be taken to include a collection of machines that individually or jointly execute the instructions 1410 to perform any one or more of the methodologies discussed herein. The machine 1400 may include processors 1404, memory/storage 1406, and I/O components 1418, which may be configured to communicate with each other such as via a bus 1402. The memory/storage 1406 may include a memory 1414, such as a main memory or other memory storage, and a storage unit 1416, both accessible to the processors 1404 such as via the bus 1402. The storage unit 1416 and memory 1414 store the instructions 1410 embodying any one or more of the methodologies or functions described herein. The instructions 1410 may also reside, completely or partially, within the memory 1414, within the storage unit 1416, within at least one of the processors 1404 (e.g., within the processor's cache memory), or any suitable combination thereof, during execution thereof by the machine 1400. Accordingly, the memory 1414, the storage unit 1416, and the memory of processors 1404 are examples of machine-readable media.

The I/O components 1418 may include a variety of components to receive input and provide output. The specific I/O components 1418 that are included in a particular machine 1400 will depend on the type of machine. For example, portable machines such as mobile phones will likely include a touch input device or other such input mechanisms, while a headless server machine will likely not include such a touch input device. The I/O components 1418 are grouped according to functionality merely for simplifying the following discussion, and the grouping is in no way limiting. In various examples, the I/O components 1418 may include input components 1428 and output components 1426.

The output components 1426 may include visual components (e.g., a display such as a light emitting diode (LED) display, a liquid crystal display (LCD), a plasma display panel (PDP), or a projector), acoustic components (e.g., speakers), haptic components (e.g., a vibratory motor, resistance mechanisms), and other signal generators. In some examples, visual components of the output components 1426 are configured to display a user interface of a language learning application, such as user interface 406 of FIG. 4. In some examples, acoustic components of the output components 1426 are configured to output synthesized speech generated by a text-to-speech (TTS) operation associated with a language unit.

The input components 1428 may include alphanumeric input components (e.g., a keyboard, a touch screen configured to receive alphanumeric input, or other alphanumeric input components), point-based input components (e.g., a mouse, a touchpad, a trackball, a joystick, or other pointing instrument), tactile input components (e.g., a physical button, a touch screen that provides location and/or force of touches or touch gestures, or other tactile input components), and audio input components (e.g., a microphone). In some examples, the audio input components are configured to capture speech from a user, and the captured speech is processed using a speech recognition operation to generate a transcribed utterance for comparison with a target utterance associated with a language learning exercise.

Communication may be implemented using a variety of technologies. The I/O components 1418 may include communication components 1440 operable to couple the machine 1400 to a network 1432 or devices 1420 via coupling 1422 and coupling 1424, respectively. For example, the communication components 1440 may include a network interface component or other suitable device to interface with the network 1432. In further examples, the communication components 1440 may include wired communication components, wireless communication components, cellular communication components, Bluetooth® components (e.g., Bluetooth® Low Energy), Wi-Fi® components, and other communication components to provide communication via other modalities. The devices 1420 may be another machine or any of a variety of peripheral devices (e.g., a peripheral device coupled via a Universal Serial Bus (USB)).

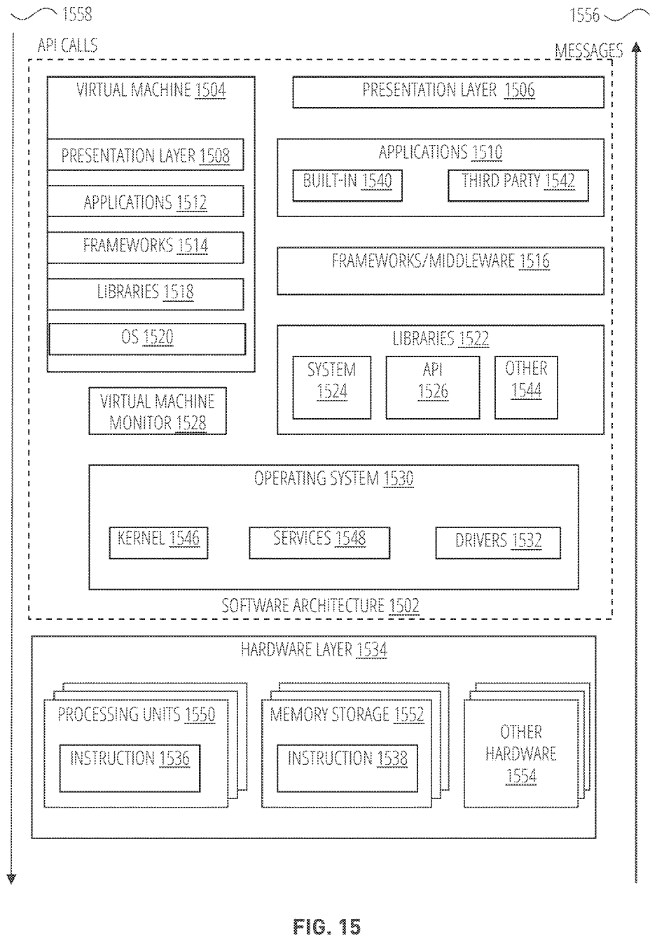

FIG. 15 is a block diagram illustrating an example of a software architecture 1502 that may be installed on a machine, according to some examples. FIG. 15 is merely a non-limiting example of a software architecture, and it will be appreciated that many other architectures may be implemented to facilitate the functionality described herein. The software architecture 1502 may be executing on hardware such as a machine 1400 of FIG. 14 that includes, among other things, processors 1404, memory/storage 1406, and I/O components 1418. A representative hardware layer 1534 is illustrated and can represent, for example, the machine 1400 of FIG. 14. The representative hardware layer 1534 comprises one or more processing units 1550 having associated executable instructions 1536. The executable instructions 1536 represent the executable instructions of the software architecture 1502. The hardware layer 1534 also includes memory or memory storage 1552, which also have executable instructions 1538. The hardware layer 1534 may also comprise other hardware 1554, which represents any other hardware of the hardware layer 1534, such as other hardware illustrated as part of the machine 1400.

In the example architecture of FIG. 15, the software architecture 1502 may be conceptualized as a stack of layers, where each layer provides particular functionality. For example, the software architecture 1502 may include layers such as an operating system 1530, libraries 1522, frameworks/middleware 1516, applications 1510, and a presentation layer 1506. Operationally, the applications 1510 or other components within the layers may invoke API calls 1558 through the software stack and receive a response, returned values, and so forth (illustrated as messages 1556) in response to the API calls 1558. The layers illustrated are representative in nature, and not all software architectures have all layers. For example, some mobile or special-purpose operating systems may not provide a frameworks/middleware 1516 layer, while others may provide such a layer. Other software architectures may include additional or different layers. The operating system 1530 may manage hardware resources and provide common services.

The operating system 1530 may include, for example, a kernel 1546, services 1548, and drivers 1532. The kernel 1546 may act as an abstraction layer between the hardware and the other software layers. For example, the kernel 1546 may be responsible for memory management, processor management (e.g., scheduling), component management, networking, security settings, and so on. The services 1548 may provide other common services for the other software layers. The drivers 1532 may be responsible for controlling or interfacing with the underlying hardware. For example, the drivers 1532 may include display drivers, audio drivers, Wi-Fi® drivers, Bluetooth® drivers, power management drivers, and other drivers depending on the hardware configuration. The libraries 1522 may provide a common infrastructure that may be utilized by the applications 1510 and/or other components and/or layers.

The libraries 1522 typically provide functionality that allows other software modules to perform tasks in an easier fashion than by interfacing directly with the underlying operating system 1530 functionality (e.g., kernel 1546, services 1548, or drivers 1532). The libraries 1522 may include system libraries 1524 (e.g., C standard library) that may provide functions such as memory allocation functions, string manipulation functions, mathematic functions, and the like. In addition, the libraries 1522 may include API libraries 1526 such as media libraries (e.g., libraries to support presentation and manipulation of audio and image media formats such as MP3, AAC, JPG, and PNG), graphics libraries (e.g., an OpenGL framework that may be used to render 2D and 3D graphic content on a display), database libraries (e.g., SQLite that may provide various relational database functions), and web libraries (e.g., WebKit that may provide web browsing functionality). The libraries 1522 may also include a variety of other libraries 1544 to provide other APIs to the applications 1510 and other software components or modules.

The frameworks 1514 (also sometimes referred to as middleware) may provide a higher-level common infrastructure that may be utilized by the applications 1510 or other software components or modules. For example, the frameworks 1514 may provide various graphical user interface functions and high-level resource management, among other functions. The frameworks 1514 may provide a spectrum of other APIs that may be utilized by the applications 1510 and/or other software components or modules, some of which may be specific to a particular operating system or platform.

The applications 1510 include built-in applications 1540 and/or third-party applications 1542. Examples of representative built-in applications 1540 may include, but are not limited to, a browser application, a media application, or a game application. In some examples, the applications 1510 include the language learning application 112 of FIG. 1.

The third-party applications 1542 may include any of the built-in applications 1540, as well as an assortment of other applications. In a specific example, the third-party applications 1542 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1542 may invoke the API calls 1558 provided by the mobile operating system such as the operating system 1530 to facilitate functionality described herein.

The applications 1510 may utilize built-in operating system functions, libraries (e.g., system libraries 1524, API libraries 1526, and other libraries 1544), or frameworks/middleware 1516 to create user interfaces to interact with users of the system. Alternatively, or additionally, in some systems, interactions with a user may occur through a presentation layer, such as the presentation layer 1506. In these systems, the application/module “logic” can be separated from the aspects of the application/module that interact with the user.

In some examples, the language learning application 112 of FIG. 1 and FIG. 4 is implemented as one of the applications 1510 and utilizes one or more of the libraries 1522, frameworks 1514, or operating system 1530 functions to perform operations described herein. For example, the language learning application 112 may utilize API libraries 1526 to access media libraries for audio playback associated with text-to-speech (TTS) operations, or to access database libraries for storing and retrieving data assets 216 of FIG. 2. The language learning application 112 may invoke API calls 1558 provided by the operating system 1530 to access I/O components 1418 of FIG. 14, including audio input components for capturing user speech and visual output components for displaying the user interface 406 of FIG. 4.

Some software architectures utilize virtual machines. In the example of FIG. 15, this is illustrated by a virtual machine 1504. The virtual machine 1504 creates a software environment where applications/modules can execute as if they were executing on a hardware machine. The virtual machine 1504 is hosted by a host operating system (e.g., the operating system 1530) and typically, although not always, has a virtual machine monitor 1528, which manages the operation of the virtual machine 1504 as well as the interface with the host operating system. A software architecture executes within the virtual machine 1504, which may include an operating system 1520, libraries 1518, frameworks 1514, applications 1512, or a presentation layer 1508. These layers of software architecture executing within the virtual machine 1504 can be the same as corresponding layers previously described or may be different.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLSTM are well-suited for the classification, processing, and prediction of time series, given time lags of unknown size and duration between events.

What is claimed is:

1. A computer-implemented method comprising:
accessing text data in a target language;
processing the text data to generate a plurality of language units representing linguistic elements of the text data;
computing, based at least in part on the text data, one or more scores associated with the language units;
generating, based at least in part on the text data, relationship instances representing relationships between select language units of the plurality of language units;
storing the language units, the one or more scores, and the relationship instances; and
responsive to detecting, in a user interface of a computing device, a selection of a user-selectable element:
retrieving a subset of the language units based on at least one of the one or more scores or the relationship instances; and
causing display of the subset of the language units in the user interface.

2. The computer-implemented method of claim 1, wherein the text data comprises one or more conversations in the target language.

3. The computer-implemented method of claim 1, wherein the plurality of language units comprises at least one of a token, a lemma, a phrase, an utterance, or a grammatical representation of an utterance.

4. The computer-implemented method of claim 1, wherein processing the text data comprises:
applying at least one of a tokenization operation, a lemmatization operation, a part-of-speech tagging operation, a morphological analysis operation, or a dependency parsing operation to the text data.

5. The computer-implemented method of claim 1, wherein processing the text data further comprises:
generating, for at least one language unit of the plurality of language units, a translation from the target language to an instruction language.

6. The computer-implemented method of claim 1, wherein the one or more scores comprise at least one of a salience score, a complexity score, a perplexity score, or a frequency score.

7. The computer-implemented method of claim 1, wherein generating the relationship instances comprises:
computing feature vectors for at least a portion of the language units; and
determining the relationship instances based at least in part on the feature vectors.

8. The computer-implemented method of claim 7, wherein computing the feature vectors comprises:
generating embeddings using at least one of a pre-trained embedding model or an embedding model trained on at least a portion of the text data.

9. The computer-implemented method of claim 1, wherein the text data is in a target language, and wherein the relationship instances comprise at least one of:
a semantic similarity relationship between two or more of the language units;
a grammatical structure similarity relationship between two or more of the language units;
a translation relationship between a language unit in the target language and a corresponding language unit in an instruction language; or
a usage example relationship between a first language unit and a second language unit in which the first language unit appears.

10. The computer-implemented method of claim 1, further comprising:
detecting a selection of a first language unit displayed in the user interface; and
responsive to detecting the selection of the first language unit, causing display, in the user interface, of one or more second language units related to the first language unit based on the relationship instances.

11. The computer-implemented method of claim 1, further comprising:
generating, based on the subset of the language units, an interactive matching exercise comprising:
a first set of user-selectable elements each corresponding to a language unit in a target language selected from the subset of the language units; and
a second set of user-selectable elements each corresponding to a translation of a respective language unit in the first set, the translation being in an instruction language different from the target language;
detecting, via the user interface, a sequence of selections associating elements of the first set with elements of the second set;
determining, for each association in the sequence of selections, whether the associated elements correspond to a matching language unit and translation pair; and
computing an accuracy score based on the determination.

12. A computing system comprising:
at least one processor; and at least one memory storing instructions that, when executed by the at least one processor, cause the computing system to perform operations comprising:
accessing text data in a target language;
processing the text data to generate a plurality of language units representing linguistic elements of the text data;
computing, based at least in part on the text data, one or more scores associated with the language units; generating, based at least in part on the text data, relationship instances representing relationships between select language units of the plurality of language units;
storing the language units, the one or more scores, and the relationship instances; and
responsive to detecting, in a user interface of a computing device, a selection of a user-selectable element:
retrieving a subset of the language units based on at least one of the one or more scores or the relationship instances; and
causing display of the subset of the language units in the user interface.

13. The computing system of claim 12, wherein the text data comprises one or more conversations in the target language.

14. The computing system of claim 12, wherein the plurality of language units comprises at least one of a token, a lemma, a phrase, an utterance, or a grammatical representation of an utterance.

15. The computing system of claim 12, wherein processing the text data comprises:
applying at least one of a tokenization operation, a lemmatization operation, a part-of-speech tagging operation, a morphological analysis operation, or a dependency parsing operation to the text data.

16. The computing system of claim 12, wherein processing the text data further comprises:
generating, for at least one language unit of the plurality of language units, a translation from the target language to an instruction language.

17. The computing system of claim 12, wherein the one or more scores comprise at least one of a salience score, a complexity score, a perplexity score, or a frequency score.

18. The computing system of claim 12, wherein generating the relationship instances comprises:
computing feature vectors for at least a portion of the language units; and
determining the relationship instances based at least in part on the feature vectors.

19. The computing system of claim 18, wherein computing the feature vectors comprises:
generating embeddings using at least one of a pre-trained embedding model or an embedding model trained on at least a portion of the text data.

20. A non-transitory computer-readable storage medium storing instructions that, when executed by at least one processor of a computing system, cause the computing system to perform operations comprising:
accessing text data in a target language; processing the text data to generate a plurality of language units representing linguistic elements of the text data;
computing, based at least in part on the text data, one or more scores associated with the language units;
generating, based at least in part on the text data, relationship instances representing relationships between select language units of the plurality of language units;
storing the language units, the one or more scores, and the relationship instances; and
responsive to detecting, in a user interface of a computing device, a selection of a user-selectable element:
retrieving a subset of the language units based on at least one of the one or more scores or the relationship instances; and
causing display of the subset of the language units in the user interface.
